(19) United States
(12) Patent Application Publication
(10) Pub. No.: US 2011/0058790 A1
(43) Pub. Date: Mar. 10, 2011

(54) SYSTEM AND METHOD FOR RECORDING AND PLAYING AUDIO/VIDEO

(75) Inventor: YU-HUNG SUN, Tu-Cheng (TW)

(73) Assignee: HON HAI PRECISION INDUSTRY CO., LTD., Tu-Cheng (TW)

(21) Appl. No.: 12/762,378

(22) Filed: Apr. 19, 2010

(30) Foreign Application Priority Data
Sep. 7, 2009 (CN) 200910306644.2

(51) Int. Cl. H04N 5/91; H04N 5/93; G11B 27/00

(52) U.S. Cl. 386/279; 386/E05.003; 386/285; 386/328

(57) ABSTRACT

In an audio/video (AV) recording process, an AV recording and playing system and method split an original video signal from a computer into a first original video signal and a second original video signal. The first original video signal is converted to a digital video signal. The second original video signal is displayed on a display device. An analog audio signal is captured and converted to a digital audio signal. The digital video signal and the digital audio signal are compressed to a compressed AV file. In an AV playing process, the system and method retrieve a compressed AV file and decompressed the file into a digital audio signal and a digital video signal. The digital video signal is converted to an analog video signal. The digital audio signal is converted to an analog audio signal.

### BACKGROUND

1. Technical Field

Embodiments of the present disclosure relate to multimedia technology, and particularly to a system and method for recording and playing audio/video (AV).

2. Description of Related Art

Display devices, such as monitors and projectors, have been widely used to display image files such as slide show presentations from computers. In some cases, it is desirable to record such presentations together with audio captured by a microphone during the presentations. Current AV recording systems are not universal and may only work with certain applications in a computer, which is inconvenient and may necessitate having many different methods and/or devices to cover all recording needs.

### BRIEF DESCRIPTION OF THE DRAWINGS

FIG. 1 is a block diagram of one embodiment of an application environment of a system for recording and playing audio/video (AV).

FIG. 2 is a schematic diagram of one embodiment of the system in FIG. 1.

FIG. 3 is a flowchart of one embodiment of a method for recording and playing AV implementing a system, such as that of FIG. 2.

### DETAILED DESCRIPTION

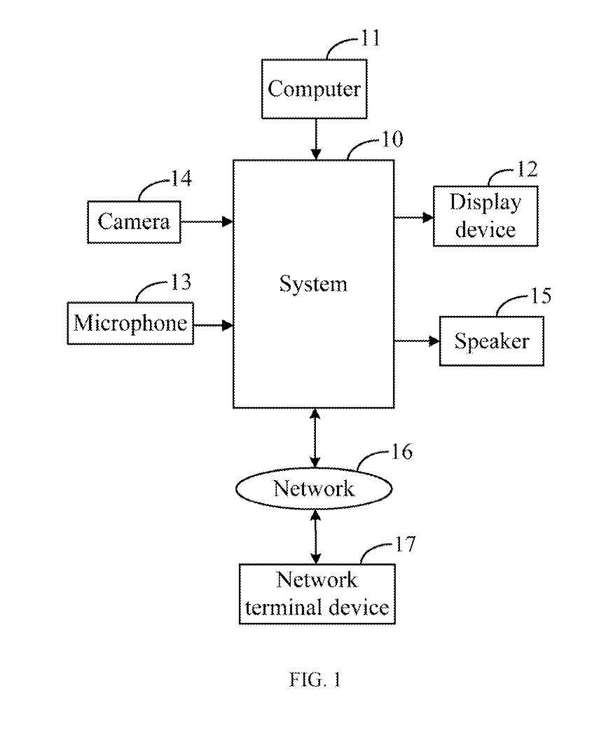

FIG. 1 is a block diagram of one embodiment of an application environment of a system 10 for recording and playing audio/video (AV). The system 10 may be connected to a computer 11, a display device 12, a microphone 13, a camera 14, and a speaker 15. The system 10 is operable to record video signals from the computer 11 and/or captured images from the camera 14, while at the same time recording audio captured by the microphone 13 to combine into one AV file. The system 10 is further operable to play video on the display device 12 and play audio over the speaker 15. The display device 12 may be a monitor or a projector. In one embodiment, the system 10 may be further connected to a network 16. The system 10 may transmit the recorded AV to at least one network terminal device 17 (only one shown in FIG. 1) via the network 16, and receive AV from the network terminal device 17 to play. The network 16 may be an intranet (e.g., a network within a company) or an extranet (e.g., the Internet).

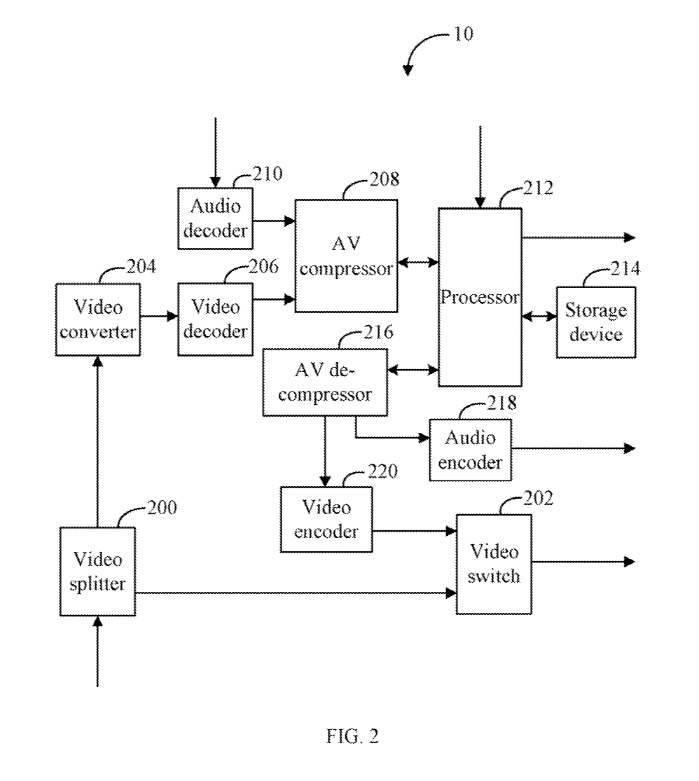

FIG. 2 is a schematic diagram of one embodiment of the system 10 in FIG. 1. The system 10 may include a video splitter 200, a video switch 202, a video converter 204, a video decoder 206, an AV compressor 208, an audio decoder 210, a processor 212, a storage device 214, an AV de-compressor 216, an audio encoder 218, and a video encoder 220.

The video splitter 200 duplicates an input of an original video signal received from the computer 11 into two outputs, consisting of a first original video signal and a second original video signal. In one embodiment, the original video signal may be a video graphics array (VGA) signal. The video splitter 200 outputs the first original video signal to the video converter 204, and outputs the second original video signal to the video switch 202.

The video converter 204 converts the first original video signal into an analog video signal. In one embodiment, the video converter 204 converts the first original video signal into a composite video signal.

The video decoder 206 decodes the analog video signal into a digital video signal, and outputs the digital video signal to the AV compressor 208. In one embodiment, the video decoder 206 converts the analog video signal into an 8-bit digital video signal.

The audio decoder 210 receives an analog audio signal captured by the microphone 13 and decodes the analog audio signal into a digital audio signal. The audio decoder 210 outputs the digital audio signal to the AV compressor 208.

The AV compressor 208 compresses the digital audio signal and the digital video signal to obtain a compressed AV file, and outputs the compressed AV file to the processor 212. In one embodiment, the AV compressor 208 may apply a moving pictures experts group (MPEG) compression algorithm, such as MPEG-1, MPEG-2, or MPEG-4, to compress the digital audio signal and the digital video signal. The AV compressor 208 may further compress video data captured by the camera 14.

In AV recording process, the processor 212 stores the compressed AV file into the storage device 214. In one embodiment, the processor 212 may transfer the compressed AV file to the network terminal device 17 via the network 16. As such, the compressed AV file can be displayed on the network terminal device 17.

In AV playing process, the processor 212 retrieves a compressed AV file from the storage device 214, and transfers the retrieved compressed AV file to the AV de-compressor 216. In one embodiment, the processor 212 may receive a compressed AV file from the network terminal device 17 via the network 16, and transfer the received compressed AV file to the AV de-compressor 216.

The AV de-compressor 216 decompresses the retrieved/received compressed video file to obtain a digital audio signal and a digital video signal. The AV de-compressor 216 outputs the digital audio signal to the audio encoder 218, and outputs the digital video signal to the video encoder 220.

The audio encoder 218 encodes the digital audio signal into an analog audio signal, and outputs the analog audio signal to the speaker 15 to play.

The video encoder 220 encodes the digital video signal into an original video signal, and outputs the original video signal to the video switch 202.

The video switch 202 selectively connects the video splitter 220 to the display device 12 or connects the video encoder 220 to the display device 12. If the video switch 202 connects the video splitter 220 to the display device 12, the second original video signal can be displayed on the display device 12. If the video switch 202 connects the video encoder 220 to the display device 12, the original video signal can be displayed on the display device 12. In one embodiment, the video switch 202 may be a logic switch.

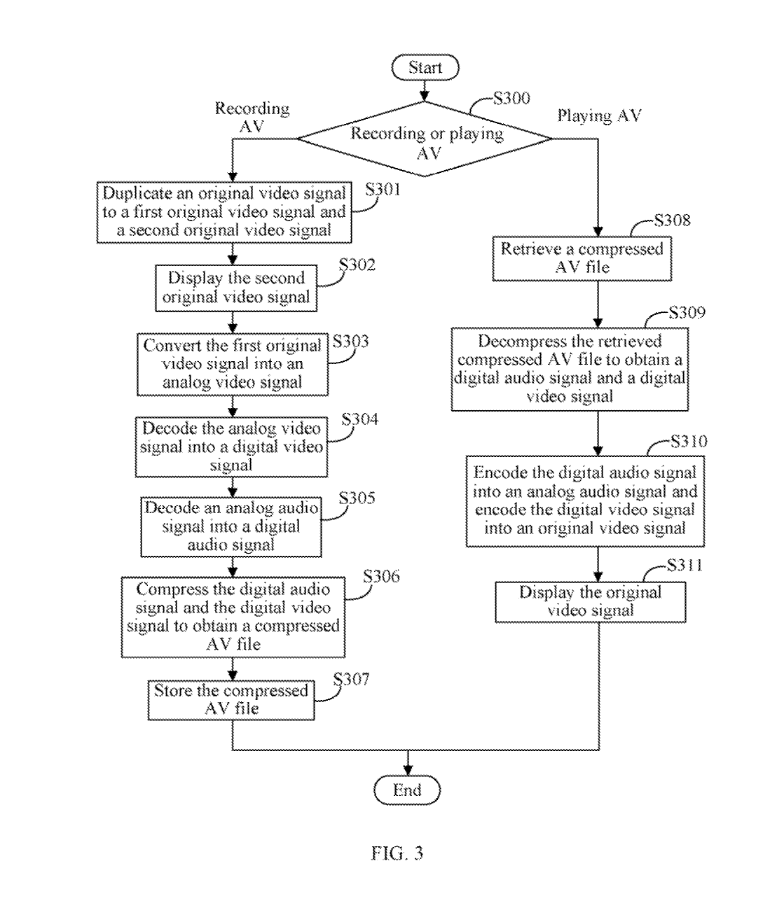

FIG. 3 is a flowchart of one embodiment of a method for recording and playing AV implementing a system, such as that of FIG. 2. Blocks S301-307 illustrate one embodiment of an AV recording process. Blocks S308-311 illustrates one embodiment of an AV playing process. Depending on the embodiments, additional blocks may be added, others removed, and the ordering of the blocks may be changed.

In block S301, the video splitter 200 duplicates an original video signal received from the computer 11 into a first original video signal and a second original video signal. The first original video signal is output to the video converter 204. The second original video signal is output to the video switch 202. In one embodiment, the original video signal may be a video graphics array (VGA) signal. Depending on the embodiment, the original video signal may be other types of video signals, such as a digital visual interface (DVI) signal or a hi-definition multimedia interface (HDMI) signal.

In block S302, the video switch 202 connects the video splitter 200 to the display device 12, so that the second original video signal can be displayed on the display device 12.

In block S303, the video converter 204 converts the first original video signal into an analog video signal. In one embodiment, the video converter 204 converts the first original video signal, such as a VGA signal, into a composite video signal. In another embodiment, the video converter 204 may convert the first original video signal into a separate video (S-Video) signal.

In block S304, the video decoder 206 decodes the analog video signal into a digital video signal, and outputs the digital video signal to the AV compressor 208. In one embodiment, the video decoder 206 converts the analog video signal into an 8-bit digital video signal. Depending on the embodiment, the video decoder 206 may convert the analog video signal into digital signals in different formats, such as a 10-bit digital video signal, a 16-bit digital video signal, or a 20-bit digital video signal.

In block S305, the audio decoder 210 receives an analog audio signal captured by the microphone 13 and decodes the analog audio signal into a digital audio signal. The audio decoder 210 outputs the digital audio signal to the AV compressor 208.

In block S306, the AV compressor 208 compresses the digital audio signal and the digital video signal to obtain a compressed AV file, and outputs the compressed AV file to the processor 212. In one embodiment, the AV compressor 208 may apply a moving pictures experts group (MPEG) compression algorithm, such as MPEG-1, MPEG-2, or MPEG-4, to compress the digital audio signal and the digital video signal. In one embodiment, the AV compressor 208 may further compress video data captured by the camera 14. The video data may be firstly transmitted from the camera 14 to the processor 212, and secondly transmitted from the processor 212 to the AV compressor 208.

In block S307, the processor 212 stores the compressed AV file into the storage device 214. In one embodiment, via the network 16, the processor 212 may transfer the compressed AV file stored in the storage device 214 to the network terminal device 17, such as a personal computer. As such, the compressed AV file can be displayed on the network terminal device 17.

In the AV playing process, in block S308, the processor 212 retrieves a compressed AV file from the storage device 214, and transfers the retrieved compressed AV file to the AV de-compressor 216. Depending on the embodiment, the processor 212 may receive a compressed AV file from the network terminal device 17 via the network 16, and transfer the received compressed AV file to the AV de-compressor 216.

In block S309, the AV de-compressor 216 decompresses the retrieved/received compressed AV file to obtain a digital audio signal and a digital video signal. The AV de-compressor 216 outputs the digital audio signal to the audio encoder 218, and outputs the digital video signal to the video encoder 220.

In block S310, the audio encoder 218 encodes the digital audio signal into an analog audio signal, and outputs the analog audio signal to the speaker 15 to play. Meanwhile, the video encoder 220 encodes the digital video signal into an original video signal, and outputs the original video signal to the video switch 202.

In block S311, the video switch 202 connects the video encoder 220 to the display device 12, so that the original video signal can be displayed on the display device 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for recording and playing audio/video (AV), comprising:
a video splitter operable to duplicate an original video signal received from a computer to a first original video signal and a second original video signal;
a video converter operable to convert the first original video signal into an analog video signal;
a video decoder operable to decode the analog video signal into a digital video signal;
an audio decoder operable to receive an analog audio signal captured by a microphone, and decode the analog audio signal into a digital audio signal;
an AV compressor operable to compress the digital audio signal and the digital video signal to obtain a compressed AV file;
a processor operable to store the compressed AV file into a storage device, or retrieve a compressed AV file from the storage device;
an AV de-compressor operable to decompress the retrieved compressed AV file to obtain a digital audio signal and a digital video signal;
an audio encoder operable to receive the digital audio signal from the AV de-compressor, encode the digital audio signal to an analog audio signal, and output the analog audio signal to a speaker to play;
a video encoder operable to receive the digital video signal from the AV de-compressor, and encode the digital video signal to the original video signal; and
a video switch operable to connect the video splitter to a display device, causing the second original video signal to be displayed on the display device, or connect the video encoder to the display device, causing the original video signal to be displayed on the display device.

2. The system of claim 1, wherein the original video signal is a video graphics array (VGA) signal.

3. The system of claim 1, wherein the AV compressor is further operable to compress video data captured by a camera.

4. The system of claim 1, wherein the processor is further operable to transfer the compressed AV file stored in the storage device to a network terminal device via a network.

5. The system of claim 4, wherein the processor is further operable to receive a compressed AV file from the network terminal device via the network.

6. The system of claim 5, wherein the AV de-compressor is further operable to decompress the received compressed AV file.

7. The system of claim 1, wherein the AV compressor applies a moving pictures experts group (MPEG) compression algorithm to compress the digital audio signal and the digital video signal.

8. A method for recording and playing audio/video (AV), in an AV recording process, the method comprising:
duplicating an original video signal received from a computer to a first original video signal and a second original video signal by a video splitter, outputting the first original video signal to a video converter, and outputting the second original video signal to a video switch;
connecting the video splitter to a display device by the video switch, causing the second original video signal to be displayed on the display device;
converting the first original video signal into an analog video signal by the video converter, and outputting the analog video signal to a video decoder;
decoding the analog video signal into a digital video signal by the video decoder, and outputting the digital video signal to an AV compressor;
receiving an analog audio signal captured by a microphone by an audio decoder, decoding the analog audio signal into a digital audio signal, and outputting the digital audio signal to the AV compressor;
compressing the digital audio signal and the digital video signal by the AV compressor to obtain a compressed AV file, and outputting the compressed AV file to a processor; and
storing the compressed AV file into a storage device by the processor; and
in an AV playing process, the method comprising:
retrieving a compressed AV file from the storage device by the processor, and transferring the retrieved compressed AV file to an AV de-compressor;
decompressing the retrieved compressed AV file by the AV de-compressor to obtain a digital audio signal and a digital video signal, outputting the digital audio signal to an audio encoder, and outputting the digital video signal to a video encoder;
encoding the digital audio signal to an analog audio signal by the audio encoder, and outputting the analog audio signal to a speaker to play;
encoding the digital video signal to an original video signal by the video encoder, and outputting the original video signal to the video switch; and
connecting the video encoder to the display device by the video switch, causing the original video signal to be displayed on the display device.

9. The method of claim 8, wherein the original video signal is a video graphics array (VGA) signal.

10. The method of claim 8, wherein the AV compressor further compresses video data captured by a camera in the AV recording process.

11. The method of claim 8, wherein the processor transfers the compressed AV file stored in the storage device to a network terminal device via a network in the AV recording process.

12. The method of claim 11, wherein the processor receives a compressed AV file from the network terminal device via the network in the AV playing process.

13. The method of claim 12, wherein the AV de-compressor decompresses the received compressed AV file.

14. The method of claim 8, wherein the AV compressor applies a moving pictures experts group (MPEG) compression algorithm to compress the digital audio signal and the digital video signal.
